(19) United States
(12) Patent Application Publication
(10) Pub. No.: US 2008/0296229 A1
(43) Pub. Date: Dec. 4, 2008

(54) Liquid treatment method and apparatus

(75) Inventors: Kazuyuki Yamasaki, Hiroshima (JP); Kazumi Chuhjoh, Takamatsu (JP); Koji Iwata, Nara (JP); Masaki Kataoka, Hiroshima (JP)

Correspondence Address: Edwards Angell Palmer & Dodge LLP, P.O. Box 55874, Boston, MA, 02205, US

(73) Assignee: Sharp Kabushiki Kaisha, Osaka-shi (JP)

(21) Appl. No.: 12/154,985

(22) Filed: May 28, 2008

(30) Foreign Application Priority Data
May 29, 2007 (JP) 2007-141422

(51) Int. Cl. B03C 1/30; B03C 1/02; B01D 53/02; B01F 3/04; C02F 1/48

(52) U.S. Cl. 210/669; 210/222; 210/223; 210/205; 210/695; 210/143

(57) ABSTRACT

The liquid treatment apparatus includes a raw water tank 1 in which a first magnetic-force nanobubble generator 51 is provided, and a treatment water tank 62 in which a second magnetic-force nanobubble generator 52 is provided. The first magnetic-force nanobubble generator 51 has a magnetic water activator 12, a microbubble generation section 8, a first gas shearing section 6, and a second gas shearing section 4. The second magnetic-force nanobubble generator 52 has a magnetic water activator 48, a microbubble generation section 46, a first gas shearing section 43, and a second gas shearing section 41. In the raw water tank 1 and the treatment water tank 62, magnetic-force nanobubble flows 3, 40 which are nanobubbles generated in water subjected to action of magnetic force by the magnetic water activators 12, 48 are generated. Thus, by a synergistic effect between radicals related to electric energy of magnetic force and radicals of nanobubbles, it becomes possible to decompose persistent organic matters and the like.

### CROSS-REFERENCE TO RELATED APPLICATIONS

This nonprovisional application claims priority under 35 U.S.C. §119(a) on Patent Application No(s). 2007-141422 filed in Japan on May 29, 2007, the entire contents of which are hereby incorporated by reference.

### BACKGROUND OF THE INVENTION

The present invention relates to a liquid treatment method and apparatus and, as an example, to a liquid treatment method and apparatus for liquids which contain organic fluorine compounds.

Organic fluorine compounds are chemically stable substances. The organic fluorine compounds, having excellent properties in terms of thermal resistance and chemical resistance in particular, are widely used as industrial materials such as surface active agents and anti-reflection films.

However, because of being chemically stable substances, organic fluorine compounds are difficult to microbially decompose. Because of their difficulty in microbial decomposition, organic fluorine compounds, when discharged into environments, make causes of issues of environmental pollutions. Perfluorooctane sulfonate (PFOS) and perfluorooctanoic acid (PFOA) as examples of the organic fluorine compounds hardly progress in decomposition in ecosystems, giving rise to a fear for influences on the ecosystems. That is, these perfluorooctane sulfonate (PFOS) and perfluorooctanoic acid (PFOA), being chemically stable, need as high temperatures as about 1000° C. or higher for their thermal decomposition while having great difficulty in decomposition by conventional microbial treatment or conventional photocatalytic or other treatments.

More specifically, bonds of carbon and fluorine, which are chemical structural formulae in organic fluorine compounds, are stable, and therefore organic fluorine compounds are not decomposed even in strong acids. Therefore, organic fluorine compounds are discharged into environments, going around the world and eventually having condensed heretofore in every living thing in the world. For instance, organic fluorine compounds have been detected even from polar bears, seals and whale as an example, coming up as an issue of international environmental pollution.

However, organic fluorine compounds, which are stable chemical substances, are difficult to microbially decompose and therefore no treatment method exists other than incinerating liquids containing organic fluorine compounds at 1000° C. or higher.

This method by incineration is the only treatment method for organic fluorine compounds so far. However, the method consumes larger amounts of fuel for larger amounts of liquid, and taking into account the issue of global warming due to increases of carbon dioxide, the method is not a rational treatment method.

Also, there is a need for treating organic fluorine compounds in tap water, underground water and the like, whereas no rational and economical treatment method is available therefor as it stands. More specifically, although water treatment methods such as rapid filtration and activated carbon adsorption are available as methods for treatment of organic fluorine compounds in tap water, underground water and the like, yet the decomposition of organic fluorine compounds cannot be expected at all from those methods.

Further, ordinary water treatment methods such as rapid filtration and activated carbon adsorption require replacement of activated carbon after the adsorption, involving such problems as time and effort for the work as well as increases in the running cost for regeneration. Particularly when organic fluorine compound-containing wastewater is treated by an ordinary wastewater treatment method such as rapid filtration or activated carbon adsorption, the replacement of activated carbon would be involved frequently, accompanied by a problem of increased running costs.

Conventionally available methods and apparatuses making use of nanobubbles include one described in JP 2004-121962A. This method and apparatus utilizes such properties of nanobubbles as decreases in buoyancy, increases in surface area, increases in surface activity, generation of local high-pressure fields, surface activating action by realization of electrostatic polarization and bactericidal action. In this method and apparatus, those actions are correlated with one another so as to improve the adsorption function for polluting components, the high-speed detergent function for substance surfaces, and the bactericidal function. Then, the method and apparatus acts to clean various kinds of substances with high functions and low environmental loads so as to fulfill purification of polluted water.

Further, a conventional method for generating nanobubbles is described in JP 2003-334548 A.

This method includes a step for, in a liquid, decomposing and gasifying part of the liquid, a step for applying ultrasonic waves in the liquid, or a step for decomposing and gasifying part of the liquid and a step for applying ultrasonic waves.

Also, JP 2004-321959 A describes a conventional waste fluid treatment apparatus using ozone microbubbles.

In this treatment apparatus, a micro-nano bubble generation device is supplied with ozone gas generated by an ozone generation device, while the micro-nano bubble generation device is supplied with waste fluid extracted from lower portion of a treatment tank via a booster pump. Also, generated ozone microbubbles are passed into the waste fluid contained in the treatment tank through an opening of a gas blowoff pipe.

However, even the use of the method that utilizes nanobubbles or ozone microbubbles as described above has not yet reached a solution of the aforementioned problems.

### SUMMARY OF THE INVENTION

Accordingly, an object of the present invention is to provide a liquid treatment method and apparatus capable of effectively decomposing persistent organic matters such as organofluoric compounds.

In order to achieve the above object, there is provided a liquid treatment apparatus comprising:

a magnetic field generation section for subjecting a liquid to action of a magnetic field; and

a nanobubble generator for generating nanobubbles in the liquid subjected to the action of the magnetic field.

According to the liquid treatment apparatus of this invention, by a synergistic effect between radicals related to electric energy of magnetic force and radicals of nanobubbles, it becomes possible to achieve a powerful oxidative decomposition of the liquid. That is, it has proved that treating the liquid with both magnetic field and nanobubbles allows unstable free radicals to be generated to far more quantities by the synergistic effect between lines of magnetic force and nanobubbles, than in the case of treatment with nanobubbles alone. Unstable free radicals have a function of grabbing electrons from other molecules so as to be stabilized. Therefore, the generation of far more quantities of unstable free radicals makes it possible to fulfill the oxidative decomposition of persistent organic fluorine compounds (e.g., PFOS (perfluorooctane sulfonate) and PFOA (perfluorooctanoic acid)).

In one embodiment of the invention, the magnetic field generation section is a magnetic force activator which releases lines of magnetic force to between N and S poles of a magnet to pass the liquid through between the N and S poles so that the liquid is subjected to action of magnetism.

According to the liquid treatment apparatus of this embodiment, by the magnet included in the magnetic force activator, it becomes possible to subject the liquid to action of lines of magnetic force so that radicals can be generated by the electric energy of the magnetic force.

In one embodiment of the invention, the nanobubble generator has a microbubble generation section, and a gas shearing section for shearing microbubbles generated in the microbubble generation section to generate nanobubbles.

According to the liquid treatment apparatus of this embodiment, nanobubbles can be produced in a way that microbubbles generated in the microbubble generation section are sheared by the gas shearing section.

In one embodiment of the invention, the gas shearing section includes a first gas shearer and a second gas shearer of a stage succeeding the first gas shearer.

According to the liquid treatment apparatus of this embodiment, the gas shearing section is so arranged that air bubbles are sheared by the first gas shearer and the second gas shearer of the stage succeeding the first gas shearer. Therefore, nanobubbles can be produced with reliability and high efficiency.

In one embodiment of the invention, the liquid treatment apparatus further comprises:

a raw liquid tank in which a first magnetic-force nanobubble generator having the magnetic force generation section and the nanobubble generator is set up; and

a rapid filter to which a nanobubble-containing liquid is introduced from the raw liquid tank;

an activated carbon adsorption tower to which a treatment liquid derived from the rapid filter is introduced; and

a treatment tank to which a treatment liquid derived from at least one of the rapid filter and the activated carbon adsorption tower is introduced, and in which a second magnetic-force nanobubble generator having the magnetic field generation section and the nanobubble generator is provided.

According to the liquid treatment apparatus of this embodiment, nanobubbles (magnetic-force nanobubbles) generated in the liquid that has been subjected to action of magnetic force last for long in the liquid, and therefore continues to be present also in the rapid filter and the activated carbon adsorption tower. Thus, the liquid can be oxidatively treated by exertion of the oxidation action of the magnetic-force nanobubbles even in rapid filter and the activated carbon adsorption tower.

In one embodiment of the invention, the liquid to be introduced is water.

According to the liquid treatment apparatus of this embodiment, various types of water can be oxidatively treated by the magnetic-force nanobubbles.

In one embodiment of the invention, the liquid to be introduced is clean water.

According to the liquid treatment apparatus of this embodiment, persistent substances (environmental hormones, trihalomethane, various types of persistent surface active agents) in the tap water as clean water can be oxidatively treated so that the tap water can be formed into safe clean water.

In one embodiment of the invention, the liquid to be introduced is wastewater.

According to the liquid treatment apparatus of this embodiment, persistent substances (environmental hormones, various types of persistent surface active agents, etc.) in the wastewater can be oxidatively treated so that the water quality can be improved.

In one embodiment of the invention, the liquid to be introduced is organic fluorine compound-containing wastewater.

According to the liquid treatment apparatus of this embodiment, persistent organic fluorine compounds contained in the wastewater can be treated economically.

In one embodiment of the invention, the liquid to be introduced is any one of treatment water after wastewater treatment, industrial water, drinking water, and bathwater.

According to the liquid treatment apparatus of this embodiment, any one of treatment water after wastewater treatment, industrial water, drinking water, and bathwater can be treated reliably at high grade, so that the rate of reuse can be improved.

In one embodiment of the invention, the liquid treatment apparatus further comprises

a gas-liquid mixing and circulating pump having the microbubble generation section, wherein

the magnetic force activator is fitted on a suction pipe of the gas-liquid mixing and circulating pump.

According to the liquid treatment apparatus of this embodiment, a liquid subjected to action of magnetic force by the magnetic force activator is caused to generate microbubbles by the microbubble generation section, and the resulting microbubbles are sheared so that nanobubbles are generated. As a result, a nanobubble-containing liquid subjected to action of magnetic force can be generated, so that a liquid having magnetic-force nanobubbles can be produced.

In one embodiment of the invention, charcoal is filled in the raw liquid tank.

According to the liquid treatment apparatus of this embodiment, microorganisms activated by the magnetic-force nanobubbles generated in the raw liquid tank can be propagated on the wood charcoal. Also, the magnetic-force nanobubbles penetrate into small voids of the wood charcoal, so that organic matters adsorbed to the wood charcoal can be oxidatively decomposed. Further, microbial treatment by the microorganisms having propagated on the wood charcoal functions as a pretreatment for the rapid filter and the activated carbon adsorption tower, so that organic matter loads on the rapid filter and the activated carbon adsorption tower can be reduced.

In one embodiment of the invention, activated carbon is filled in the raw liquid tank.

According to the liquid treatment apparatus of this embodiment, there can be expected, from the magnetic-force nanobubbles generated in the raw liquid tank, (1) oxidation action by free radicals, (2) activation action of microorganisms having propagated on the activated carbon, (3) decomposition action of liquid components adsorbed by the activated carbon, (4) detergent action for activated carbon surfaces, and the like. By these actions, improvement of the treatment liquid quality as well as prolongation of the life of the activated carbon to its replacement can be achieved.

In one embodiment of the invention, a string-shaped type polyvinylidene chloride filler is filled in the raw liquid tank.

According to the liquid treatment apparatus of this embodiment, microorganisms activated by the magnetic-force nanobubbles generated in the raw liquid tank can be propagated on the string-shaped type polyvinylidene chloride filler. Further, treatment by the microorganisms having propagated on the string-shaped type polyvinylidene chloride filler functions as a pretreatment for the rapid filter and the activated carbon adsorption tower, so that organic matter loads on the rapid filter and the activated carbon adsorption tower can be reduced.

In one embodiment of the invention, a surface active agent is added to the treatment tank.

According to the liquid treatment apparatus of this embodiment, by adding a small amount of a highly decomposable surface active agent to the treatment tank, a large amount of magnetic-force nanobubbles can be produced in the treatment tank. Thus, backwashing in the rapid filter and the activated carbon adsorption tower can be carried out in short time and with high efficiency.

It is noted here that although addition of a surface active agent could be considered as furthering pollutions by surface active agents, yet a variety of surface active agents which are of good microbial decomposability are commercially available and so adding a highly decomposable surface active agent is effective for production of high amounts of nanobubbles. Surface active agents that have been problematic in terms of environmental pollution are persistent surface active agents such as organic fluorine compounds.

In one embodiment of the invention, the liquid treatment apparatus further comprises:

a first oxidation-reduction potentiometer for measuring an oxidation-reduction potential of the liquid in the raw liquid tank;

a second oxidation-reduction potentiometer for measuring an oxidation-reduction potential of the liquid in the treatment tank; and

an oxidation-reduction potential controller to which first, second signals representing oxidation-reduction potentials measured by the first, second oxidation-reduction potentiometers are inputted and from which control signals based on the inputted signals are outputted to the first, second magnetic-force nanobubble generators to perform on/off control of operation of the first, second magnetic-force nanobubble generators.

According to the liquid treatment apparatus of this embodiment, since the operation of the first, second magnetic-force nanobubble generators is on/off controlled based on an oxidation-reduction potential in the raw liquid tank and an oxidation-reduction potential in the treatment tank, it becomes possible to control the operation of the first magnetic-force nanobubble generator and the second magnetic-force nanobubble generator in accordance with properties and quality of the liquid in the raw liquid tank and the treatment tank.

That is, there is a correlation between the generation quantity of magnetic-force nanobubbles and the oxidation-reduction potential in each of the individual tanks (raw liquid tank and treatment tank), and the operation of the first magnetic-force nanobubble generator and the second magnetic-force nanobubble generator is on/off controlled by a control signal outputted by the oxidation-reduction potential controller. In other words, the oxidation-reduction potential controller is enabled to control the generation quantity of magnetic-force nanobubbles by automatic control in accordance with the quality of the liquid that flows into each of the tanks.

It also becomes possible to control the generation quantity of magnetic-force nanobubbles in accordance with the liquid quality in the backwashing process. Exerting such control of the operation of the first, second magnetic-force nanobubble generators makes it possible to control the quantity of magnetic-force nanobubbles to an optimum one in each of the tanks.

In one embodiment of the invention, a plurality of the first magnetic-force nanobubble generators are provided for the raw liquid tank, and

a plurality of the second magnetic-force nanobubble generators are provided for the treatment tank, the liquid treatment apparatus further comprising:

a first oxidation-reduction potentiometer for measuring an oxidation-reduction potential of the liquid in the raw liquid tank;

a second oxidation-reduction potentiometer for measuring an oxidation-reduction potential of the liquid in the treatment tank; and

an oxidation-reduction potential controller to which first, second signals representing oxidation-reduction potentials measured by the first, second oxidation-reduction potentiometers are inputted and from which control signals based on the inputted signals are outputted to the plurality of the first, second magnetic-force nanobubble generators to perform control of a number of operating ones out of the first, second magnetic-force nanobubble generators.

According to the liquid treatment apparatus of this embodiment, since the number of operating ones out of the first, second magnetic-force nanobubble generators is controlled based on an oxidation-reduction potential in the raw liquid tank and an oxidation-reduction potential in the treatment tank, it becomes possible to control the operation of the first, second magnetic-force nanobubble generators in accordance with properties and quality of the liquid in each of the raw liquid tank and the treatment tank. That is, there is a correlation between the generation quantity of magnetic-force nanobubbles and the oxidation-reduction potential in each of the individual tanks (raw liquid tank and treatment tank), and the number of operating ones out of the first, second magnetic-force nanobubble generators can be controlled based on a control signal outputted by the oxidation-reduction potential controller. By the oxidation-reduction potential controller exerting such automatic control based on the oxidation-reduction potential of each tank, it becomes possible to control the generation quantity of magnetic-force nanobubbles in accordance with the quality of the liquid that flows into each of the tanks by controlling the number of operating ones out of the first, second magnetic-force nanobubble generators. It also becomes possible to control the generation quantity of magnetic-force nanobubbles in accordance with the liquid quality in the backwashing process. By exerting such control of the number of operating ones out of the first, second magnetic-force nanobubble generators, it becomes possible to control the quantity of magnetic-force nanobubbles to an optimum one in each of the tanks.

Also, there is provided a liquid treatment method comprising the step of passing a liquid through a magnetic field so that nanobubbles are generated in the liquid passed through the magnetic field.

According to the liquid treatment method of the invention, by a synergistic effect between radicals related to electric energy of magnetic force and radicals of nanobubbles, it becomes possible to achieve a powerful oxidative decomposition of the liquid. That is, it has proved that treating the liquid with both magnetic field and nanobubbles allows unstable free radicals to be generated to far more quantities by the synergistic effect between lines of magnetic force and nanobubbles, than in the case of treatment with nanobubbles alone. It has also proved that the unstable free radicals generated in far more quantities, by virtue of their function of grabbing electrons from other molecules so as to be stabilized, fulfill the oxidative decomposition of persistent organic fluorine compounds.

In one embodiment of the invention, the liquid is passed through a magnetic-force nanobubble generator in which a magnetic field generation section and a nanobubble generator are connected in sequence so that a magnetic-force nanobubble-containing liquid is generated.

According to the liquid treatment method of this embodiment, since a magnetic-force nanobubble-containing liquid is generated by passing the liquid through the magnetic-force nanobubble generator, it becomes possible to fulfill the oxidative decomposition of persistent organic fluorine compounds as described above.

In one embodiment of the invention, the nanobubble generator has a microbubble generation section, and a gas shearing section for shearing microbubbles generated in the microbubble generation section to generate nanobubbles.

According to the liquid treatment method of this embodiment, nanobubbles can be produced in a way that microbubbles generated in the microbubble generation section are sheared by the gas shearing section.

In one embodiment of the invention, the liquid which has been passed through the magnetic field and in which nanobubble have been generated is treated in an activated carbon adsorption tower.

According to the liquid treatment method of this embodiment, there can be expected, from the magnetic-force nanobubbles, (1) oxidation action by free radicals, (2) activation action of microorganisms having propagated on the activated carbon, (3) decomposition action of liquid components adsorbed by the activated carbon, (4) detergent action for activated carbon surfaces, and the like. By these actions, improvement of the treatment liquid quality as well as prolongation of the life of the activated carbon to its replacement can be achieved.

In one embodiment of the invention, the liquid treatment method further comprises the step of:

backwashing the activated carbon adsorption tower with a nanobubble-containing backwash liquid having nanobubbles contained in a backwash liquid or with a magnetic-force nanobubble-containing backwash liquid obtained by subjecting the nanobubble-containing backwash liquid to action of a magnetic field.

According to the liquid treatment method of this embodiment, by the oxidation, activation, decomposition and detergent actions of the magnetic-force nanobubbles described in (1) to (4) above, the backwashing power of the activated carbon adsorption tower can be improved, so that improvement of the treatment liquid quality as well as prolongation of the life of the activated carbon to its replacement can be achieved.

In one embodiment of the invention, the liquid treatment method further comprises the step of:

filtering the liquid, which has been passed through the magnetic field and in which nanobubbles have been generated, by means of a filtering unit or a tank filter.

According to the liquid treatment method of this embodiment, there can be expected, from nanobubbles or magnetic-force nanobubbles, (1) oxidation action by free radicals, (2) detergent action for filtering material surfaces, and the like.

In one embodiment of the invention, the liquid treatment method further comprises the step of:

backwashing the filtering unit or a tank filter with a nanobubble-containing backwash liquid having nanobubbles contained in a backwash liquid or with a magnetic-force nanobubble-containing backwash liquid obtained by subjecting the nanobubble-containing backwash liquid to action of a magnetic field.

According to the liquid treatment method of this embodiment, there can be expected, from nanobubbles or magnetic-force nanobubbles, (1) oxidation action by free radicals, (2) detergent action for filtering material surfaces, and the like, by which improvement of the power for backwashing the filtering unit or the tank filter can be expected.

According to the liquid treatment apparatus of the invention, by a synergistic effect between radicals related to electric energy of magnetic force and radicals of nanobubbles, it becomes possible to achieve a powerful oxidative decomposition of the liquid. That is, it has proved that treating the liquid with both magnetic field and nanobubbles allows unstable free radicals to be generated to far more quantities by the synergistic effect between lines of magnetic force and nanobubbles, than in the case of treatment with nanobubbles alone. Unstable free radicals have a function of grabbing electrons from other molecules so as to be stabilized. Therefore, the generation of far more quantities of unstable free radicals makes it possible to fulfill the oxidative decomposition of persistent organic fluorine compounds.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIG. 1 is a view schematically showing a first embodiment of the water treatment apparatus in the present invention;

FIG. 2 is a view schematically showing a second embodiment of the water treatment apparatus in the present invention;

FIG. 3 is a view schematically showing a third embodiment of the water treatment apparatus in the present invention;

FIG. 4 is a view schematically showing a fourth embodiment of the water treatment apparatus in the present invention;

FIG. 5 is a view schematically showing a fifth embodiment of the water treatment apparatus in the present invention;

FIG. 6 is a view schematically showing a sixth embodiment of the water treatment apparatus in the present invention;

FIG. 7 is a view schematically showing a seventh embodiment of the water treatment apparatus in the present invention;

FIG. 8 is a view schematically showing an eighth embodiment of the water treatment apparatus in the present invention; and

FIG. 9 is a view schematically showing a ninth embodiment of the water treatment apparatus in the present invention.

### DETAILED DESCRIPTION OF THE INVENTION

Hereinbelow, the present invention will be described in detail by way of embodiments thereof illustrated in the accompanying drawings.

### First Embodiment

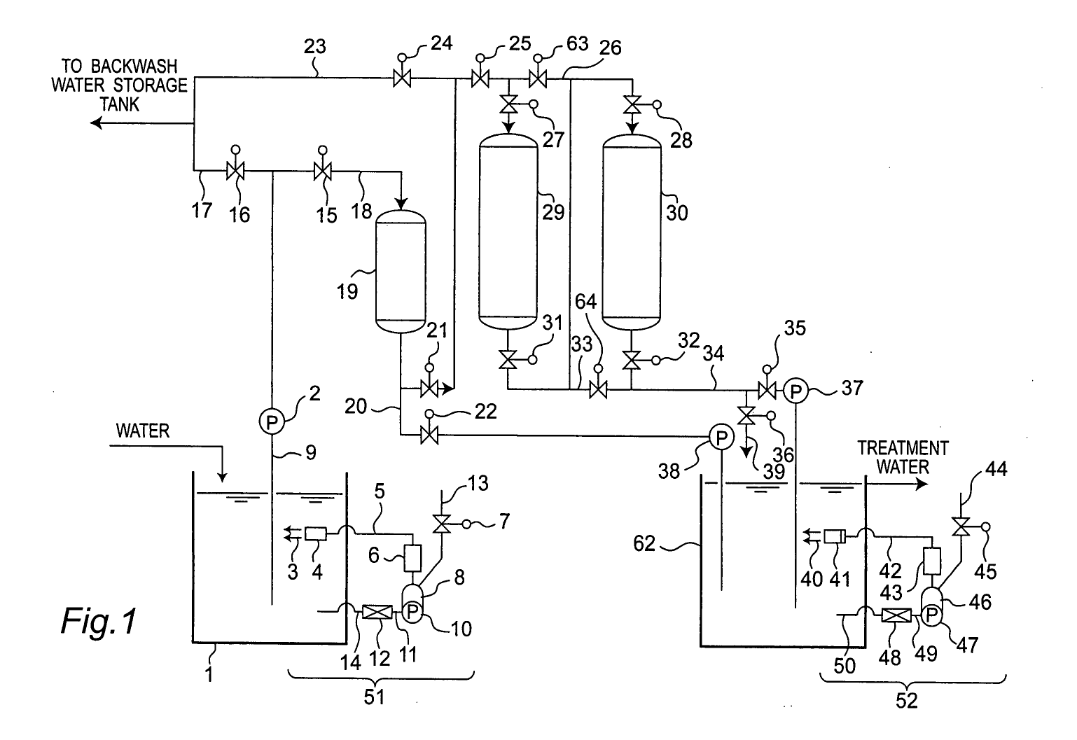

FIG. 1 is a view schematically showing a first embodiment of the liquid treatment apparatus of the invention.

Designated by reference numeral 1 is a raw water tank, to which water as a liquid to be treated is introduced. It is noted that the water may be clean water, underground water, reuse water, drain water, industrial water, drinking water, bathwater, and the like. In this raw water tank 1, a first magnetic-force nanobubble generator 51 is set up. The first magnetic-force nanobubble generator 51 includes a magnetic water activator 12 as a magnetic-field generation section connected to a suction pipe 14, and a gas-liquid mixing and circulating pump 10 having a microbubble generation section 8 connected to the magnetic water activator 12 by a suction pipe 11. Also, the first magnetic-force nanobubble generator 51 has a first gas shearing section 6 connected to the gas-liquid mixing and circulating pump 10, and a second gas shearing section 4 connected to the first gas shearing section 6 by a pipe 5. Further, an air intake pipe 13 is connected to the microbubble generation section 8, and an electric needle valve 7 is fitted on the air intake pipe 13.

In this first magnetic-force nanobubble generator 51, water introduced into the raw water tank 1 is introduced into the magnetic water activator 12 through the suction pipe 14 so as to be subjected to action of a magnetic field. In the water that has been subjected to the action of the magnetic field, microbubbles are generated by the microbubble generation section 8, and further the microbubbles are sheared by the first, second gas shearing sections 4, 6, so that magnetic-force nanobubble flows 3 formed of magnetic-force nanobubbles are generated from the second gas shearing section 4. It is noted that the term “magnetic-force nanobubbles” refers to nanobubbles generated in a liquid that has been subjected to action of magnetic force.

As magnetic-force nanobubbles are discharged into the raw water tank 1, unstable free radicals due to the magnetic-force nanobubbles are generated in the water within the raw water tank 1. These free radicals grab electrons from pollutants contained in the water so as to stabilize themselves, thus oxidizing the pollutants in the treatment water. As a result, the treatment water is oxidation treated. Further, the magnetic-force nanobubbles last for long in the treatment water, so that those nanobubbles are contained in the treatment water.

Then, under the condition that an electric valve 15 is open while an electric valve 16 is closed, a raw water tank pump 2 set for the raw water tank 1 is operated, by which the treatment water is introduced from the raw water tank 1 via a pipe 9, the electric valve 15 and a pipe 18 into a rapid filter 19.

In the rapid filter 19, anthracite as a coal-based filtering material is filled. The purpose of this rapid filter 19 is to filtrate suspended matters of the treatment water. The treatment water that has come out of the rapid filter 19 then passes through electric valves 21, and an electric valve 27 so as to be introduced into a first activated carbon adsorption tower 29. Subsequently, via electric valves 31 and 28, the treatment water is introduced into a second activated carbon adsorption tower 30.

The operation described above is conditioned by the statuses of the electric valve 21 being open, the electric valve 25 open, the electric valve 27 open, the electric valve 31 open, the electric valve 28 open, an electric valve 32 open, and an electric valve 36 open, and meanwhile an electric valve 22 being closed, an electric valve 24 closed, an electric valve 63 closed, an electric valve 64 closed, and an electric valve 35 closed. Concrete control for these statuses is automatically performed by a sequencer (not shown) within a control panel (not shown).

Then, since activated carbon is filled in the first activated carbon adsorption tower 29 and the second activated carbon adsorption tower 30, organic matters in the treatment water are adsorbed to the activated carbon. As for the type of activated carbon, in this case, granular coconut-husk activated carbon is adopted as an example. Although coal-based activated carbons are commercially available, granular coconut-husk activated carbon is adopted from its past actual performance. However, the type of activated carbon may finally be determined depending on the contents of the liquid or preliminary experiments.

Then, during continued operation of passing the treatment water through the first activated carbon adsorption tower 29 and the second activated carbon adsorption tower 30, microorganisms propagate naturally on the activated carbon. In this case, since magnetic-force nanobubbles are contained in the treatment water, microorganisms that have propagated within the first activated carbon adsorption tower 29 and the second activated carbon adsorption tower 30 are more strongly activated so that organic matters adsorbed by the activated carbon can be biologically decomposed. In particular, magnetic-force nanobubbles, which last in the treatment water much longer than microbubbles, do last up to the second activated carbon adsorption tower 30 so as to strongly activate the microorganisms that have propagated on the activated carbon, by which organic matters adsorbed by the activated carbon are decomposed rationally.

Also, magnetic-force nanobubbles generate free radicals, thereby activating microorganisms while oxidizing the organic matters in the treatment water as well, functioning also to reduce the organic matter concentration in the treatment water. Further, organic matters contained in the treatment water and physically adsorbed by the activated carbon are decomposed by the microorganisms that have propagated on the activated carbon as described above, thus resulting in a state that activated carbon is automatically regenerated, which is a state called biological activated carbon.

In this connection, whereas biological activated carbon has traditionally been found in cases of less influent organic-matter loads, such as when the raw water of clean water is purified, the phenomenon of biological activated carbon has been a rare case in wastewater of more organic-matter loads. By contrast, in cases of treatment water containing magnetic-force nanobubbles, much more increased purifying power causes the phenomenon of biological activated carbon, i.e. automatic regeneration of activated carbon, to take place.

Also as described above, with magnetic-force nanobubbles contained in the treatment water, the magnetic-force nanobubbles pass through activated carbon while oxidizing organic matters contained in the treatment water. Thus, there is a phenomenon that blockage of one activated carbon piece with another activated carbon piece due to the organic matters of the activated carbon is almost all eliminated.

Next, the backwash cleaning of activated carbon is explained. The backwash cleaning is known as “backwashing” in the industry and hereinafter referred to so. When the water passage through the activated carbon has been executed for a long duration or when the treatment water has increased in its organic-matter concentration, the first activated carbon adsorption tower 29 and the second activated carbon adsorption tower 30 increase in resistance, i.e., in pressure loss. In such a case, the first activated carbon adsorption tower 29 and the second activated carbon adsorption tower 30 are backwashed. The individual electric valves differ in their open/close conditions between water passage and backwashing.

The backwashing work for the first activated carbon adsorption tower 29 and the second activated carbon adsorption tower 30 is performed while the raw water tank pump 2 is stopped and an activated-carbon adsorption tower backwash pump 37 is operated. The time for the backwashing, although differing depending on the degree of water passage resistance of activated carbon, falls within a range from 10 to 20 minutes, in general.

In this backwashing work, the electric valve 35 near the activated-carbon adsorption tower backwash pump 37 is set open, and the electric valve 24 connected to a backwash water storage tank (not shown) by a pipe 23 is set open. More specifically, the electric valves are so operated that the electric valve 21 is closed, the electric valve 25 is open, the electric valve 27 is open, the electric valve 31 is open, the electric valve 28 is open, the electric valve 32 is open, the electric valve 36 is closed, the electric valve 22 is closed, the electric valve 24 is open, the electric valve 63 is open, the electric valve 64 is open, and the electric valve 35 is open. These open/closed conditions for electric valves apply to a case of two-tower simultaneous backwashing. In other cases, however, backwashing may be done tower by tower, one at a time. In this case, open/close conditions for the individual electric valves appropriate to the case of one-by-one tower backwashing should be adopted. In addition, in FIG. 1, reference numerals 26, 33 and 34 denote pipes.

Before the backwashing of activated carbon, preparations for backwash water stored in a treatment water tank 62 are done. There has been no instance, heretofore, in which magnetic-force nanobubbles are contained in the backwash water for the first activated carbon adsorption tower 29 and the second activated carbon adsorption tower 30 or in the backwash water for the rapid filter 19. When magnetic-force nanobubbles are contained in the backwash water for the first activated carbon adsorption tower 29 and the second activated carbon adsorption tower 30 as well as in the backwash water for the rapid filter 19, the detergent effect on filtering material surfaces is increased by the detergent power inherent in nanobubbles so that backwash time can be reduced.

For the treatment water tank 62, the activated-carbon adsorption tower backwash pump 37 and a rapid filter backwash pump 38 are set up. By adjusting the backwashing quantity with the activated-carbon adsorption tower backwash pump 37, it becomes possible to backwash the first activated carbon adsorption tower 29 and the second activated carbon adsorption tower 30 simultaneously. It is also possible to backwash those activated carbon adsorption towers, one by one, singly. These backwashing conditions may be determined depending on the contents of the liquid or the operation conditions.

On the other hand, backwashing for the rapid filter 19 is automatically performed by a sequencer (not shown) under the conditions that while the rapid filter backwash pump 38 is operated, the electric valve 22 connected to a pipe 20 is open, the electric valve 21 is closed, the electric valve 15 connected to the pipe 18 is open, and the electric valve 16 connected to a pipe 17 is open. Starting of this backwashing may be effected selectively either when the pressure loss of the rapid filter 19 has come to a set value or higher, or as it has previously been by a timer. The selection of either one may be determined by water quality of the liquid or the like. Further, it is also allowable to make up a system for performing the backwashing when either one of the two conditions, the pressure loss setting and the timer setting, is satisfied. The setting of these conditions may be selected as the case may be.

Moreover, with regard to the start conditions for the backwashing of the first activated carbon adsorption tower 29 and the second activated carbon adsorption tower 30, the same start conditions as those for the backwashing of the rapid filter 19 may be adopted.

Next, production of backwash water in the treatment water tank 62 and the like are explained in detail. In this treatment water tank 62, a second magnetic-force nanobubble generator 52 is set up. This second magnetic-force nanobubble generator 52 includes a magnetic water activator 48 as a magnetic field generation section connected to a suction pipe 50, and a gas-liquid mixing and circulating pump 47 having a microbubble generation section 46 connected to the magnetic water activator 48 by a suction pipe 49. Also, the second magnetic-force nanobubble generator 52 includes a first gas shearing section 43 connected to the gas-liquid mixing and circulating pump 47, and a second gas shearing section 41 connected to the first gas shearing section 43 by a pipe 42. Further, an air intake pipe 44 is connected to the microbubble generation section 46, and an electric needle valve 45 is fitted on the air intake pipe 44.

Into this treatment water tank 62, treatment water derived from the first activated carbon adsorption tower 29 and the second activated carbon adsorption tower 30 is introduced via the pipes 33, 34 and a pipe 39 on which the electric valve 36 is fitted.

The second magnetic-force nanobubble generator 52 discharges magnetic-force nanobubbles from the second gas shearing section 41 into the treatment water tank 62, generating a magnetic-force nanobubble flow 40. As magnetic-force nanobubbles are discharged into the treatment water tank 62, unstable free radicals due to the magnetic-force nanobubbles are generated in the treatment water within the treatment water tank 62. These free radicals grab electrons from pollutants contained in the treatment water so as to stabilize themselves, thus oxidizing the pollutants in the treatment water. As a result, the treatment water is oxidation treated. Further, the magnetic-force nanobubbles last for long in the water, so that those nanobubbles are contained in the backwash water. It is noted that the term “magnetic-force nanobubbles” refers to nanobubbles generated in a liquid that has been subjected to action of magnetic force.

In this way, as magnetic-force nanobubbles are contained In the backwash water, a detergent effect is effectively fulfilled against the blockage of the filtering material of the rapid filter 19 during the backwashing process. Further, a detergent effect is effectively fulfilled against the blockage of activated carbon of the first activated carbon adsorption tower 29 and the second activated carbon adsorption tower 30. As a result of this, the backwash time can be reduced as a further effect.

Next, an explanation of magnetic-force nanobubbles will be given below.

For the explanation of magnetic-force nanobubbles, the first magnetic-force nanobubble generator 51 and the second magnetic-force nanobubble generator 52 are first described, where the nanobubble generator is first described and a magnetic water activator as an added magnetic force generation section is later described. Also as to nano-bubble generators, whereas two nanobubble generators, the first magnetic-force nanobubble generator 51 and the second magnetic-force nanobubble generator 52, are involved in this case, the principle is common therebetween. Therefore, the following description will be given on the mechanism of the nanobubble generator that makes up the first magnetic-force nanobubble generator 51. This nanobubble generator is comprised of a gas-liquid mixing and circulating pump 10, a microbubble generation section 8, a first gas shearing section 6, a second gas shearing section 4, an electric needle valve 7 and pipes that serve for their coupling.

In the nanobubble generator, nanobubbles are produced roughly through a first step and a second step.

The first step is explained briefly. In the microbubble generation section 8, with pressure control exerted hydrodynamically, gas is sucked through a negative-pressure formation portion and put into a high-speed fluid motion to form a negative-pressure portion, so that microbubbles are generated. In brief for a better understanding, water and air are self supplied, mixed and dissolved effectively, and pressure fed to produce microbubble whitened water, which is the first step.

Next, the second step is described briefly. In the first gas shearing section 6 and the second gas shearing section 4, a high-speed fluid motion is effected to form a negative-pressure portion so that microbubbles are generated. Then, the microbubbles are introduced through liquid piping to the first gas shearing section 6 and the second gas shearing section 4, being sheared as fluid motions, by which nanobubbles are generated from the microbubbles.

Next, the first step and the second step are described in more detail.

(First Step in Nanobubble Generator)

The gas-liquid mixing and circulating pump 10 used in the nanobubble generator is a high-lift pump having a lift of 40 m or more (i.e., a high pressure of 4 kg/cm²), as an example. That is, the gas-liquid mixing and circulating pump 10 having the microbubble generation section 8, in many cases, needs to be selected as a high-lift pump which is stable in torque and two-pole type. It is noted that pumps comes in two-pole and four-pole types, where the two-pole type is more stable in torque than the four-pole type. Also, the gas-liquid mixing and circulating pump 10 requires pressure control, and the rotating speed of this high-lift pump is controlled by the rotating-speed controller (generally called inverter) to obtain a pressure suited to the purpose. Thus, with a purpose-suited pressure, microbubbles uniformized in bubble size can be produced.

Now, the mechanism of generation of microbubbles in the gas-liquid mixing and circulating pump 10 having the microbubble generation section 8 is described.

In the microbubble generation section 8, with the aim of generating microbubbles, a liquid-gas mixed phase swirling flow is first generated, and a gas void portion for making a high-speed swirling is formed in a central portion of the microbubble generation section 8. Next, the gas void portion is narrowed into a tornado-like shape by pressure, so that a rotational sheared flow swirling at higher speed is generated. Air (which may be carbonic acid gas) as a gas is automatically fed to the gas void portion by utilizing a negative pressure (minus pressure). Further, the mixed phase flow is rotated while being cut and pulverized. This cutting and pulverization is effected by swirling-speed differences between inner-and-outer gas-liquid two-phase fluids in vicinities of the apparatus outlet. The rotational speed in this case is 500 to 600 rotations per second.

That is, in the microbubble generation section 8, gas is sucked in through the negative-pressure formation portion by exerting hydrodynamic pressure control, and put into a high-speed fluid motion by a high-lift pump, to form the negative-pressure portion, so that microbubbles are generated. In brief, for an easier understanding, water and air are self supplied, and mixed and dissolved effectively by a high-lift pump, and pressure fed to produce microbubble whitened water, which is the first step. It is noted that the operation of the gas-liquid mixing and circulating pump 10 is set by signals of the sequencer (not shown). The microbubble generation section 8 is internally formed into, for example, an elliptical shape and, for the largest effect, a perfectly circular shape, and moreover mirror finished to reduce the internal friction. Also, for control of the swirling turbulent flow of the fluid, a groove with a groove depth of 0.3 mm to 0.6 mm and a groove width of 0.8 mm or less is provided inside the microbubble generation section 8.

(Second Step in Nanobubble Generator)

In order that microbubbles generated in the gas-liquid mixing and circulating pump 10 having the microbubble generation section 8 are pressure fed to the first gas shearing section 6 through liquid piping, the pipe size is further narrowed in the first gas shearing section 6 and the second gas shearing section 4 after the first step, while the microbubbles are put into a high-speed fluid motion so as to be narrowed into a tornado-like shape, so that a rotational sheared flow that swirls at even higher speed is generated. Thus, nanobubbles are generated from microbubbles, while an ultrahigh-temperature extreme reaction field is formed.

In this connection, the reason that two gas shearing sections, the first gas shearing section 6 and the second gas shearing section 4, are provided is to generate larger amounts of nanobubbles. The two-stage makeup of gas shearing sections allows nanobubbles to be generated in more quantities than one-stage makeup of a gas shearing section. Thus, with an ultrahigh-temperature extreme reaction field formed, a high-temperature, high-pressure state occurs locally, allowing unstable free radicals to be generated in large amounts, where heat is generated at the same time.

In addition, the first gas shearing section 6 and the second gas shearing section 4 are generally made of stainless steel, and formed each into an elliptical shape or, preferably, a perfectly circular shape. Also, the first gas shearing section 6 and the second gas shearing section 4 each have a small hole formed therein, whose discharge aperture is optimally 4 mm to 9 mm.

Next, the “high-speed fluid motion” in the foregoing first step is explained. In order to generate microbubbles in the microbubble generation section 8, first as a “high-speed fluid motion,” a blade which is called pump impeller is rotated at high speed so that a liquid-and-gas mixed phase swirling flow is generated, by which a gas void portion for high-speed swirling is formed in the central portion of the microbubble generation section 8. Next, the void portion is narrowed into a tornado-like shape by pressure, so that a rotational sheared flow swirling at higher speed is generated. Air (which may be carbonic acid gas) as a gas is self fed to the gas void portion. Further, the mixed phase flow is rotated while the void portion is cut and pulverized. This cutting and pulverization is effected by swirling-speed differences between inner-and-outer gas-liquid two-phase fluids in vicinities of the outlet of the microbubble generation apparatus. Also, it has been found out that the rotational speed is 500 to 600 rotations per second.

If the metal that forms the microbubble generation section 8 is thin in thickness, operation of the gas-liquid mixing and circulating pump 10 causes vibrations to occur, so that fluid motion energy propagates and escapes outside as vibrations. This would lead to declines of the high-speed fluid motion, i.e. high-speed swirling and shearing energy, which is required. For this reason, the thickness of the metal that forms the microbubble generation section 8 is set to 6 mm to 12 mm as an example.

Next, “shearing as fluid motion” in the foregoing second step is explained. In order that microbubbles generated in the gas-liquid mixing and circulating pump 10 having the microbubble generation section 8 are pressure fed to the first gas shearing section 6 and the second gas shearing section 4 through liquid piping, the pipe size is further narrowed in the first gas shearing section 6 and the second gas shearing section 4 after the first step, while the microbubbles are put into a high-speed fluid motion so that a rotational sheared flow narrowed into a tornado-like shape and swirling at even higher speed is generated.

Next, a “negative-pressure formation portion” in the second step is explained. The “negative-pressure formation portion” is generated by swirling-speed differences between inner-and-outer gas-liquid two-phase fluids in vicinities of the apparatus outlet. As described above, the rotating speed is 500 to 600 rotations per second. The “negative-pressure portion” is explained as well. the “negative-pressure portion” refers to a region in a gas-liquid mixture where the pressure is smaller in comparison to surrounding places.

Described above is the mechanism of the nanobubble generation in the first magnetic-force nanobubble generator 51. The nanobubble generation in the second magnetic-force nanobubble generator 52 is similar in principle to the nanobubble generation in the first magnetic-force nanobubble generator 51.

Next, magnetic force generated by the magnetic water activators 12, 48 as magnetic field generation sections in the first magnetic-force nanobubble generator 51 and the second magnetic-force nanobubble generator 52 is explained. The magnetic force generated by the magnetic water activators 12, 48 is magnetic force which is to be imparted to a liquid by passing the liquid through between N and S poles of a magnet. Here is adopted a magnetic water activator as an example of equipment for imparting magnetic force to the liquid. It is said that a liquid, when subjected to magnetic activation process, i.e. when given magnetic force, has its molecular groups (clusters) subdivided into about 1/10 sizes. Upon this occurrence, with influences of magnetic force added at the same time, bond angles of oxygen molecules or hydrogen molecules and the like in the liquid molecules are changed from normal to various angles, where those molecules, while restoring their original state, begin to go into vigorous spin motion. As a result of this spin motion, oxygen and far infrared radiation in the air are captured in the liquid, causing the bactericidal action to occur in the liquid. As a consequence, the liquid results in a state of small clusters (groups), active motions of molecules and large-amount containment of oxygen molecules and far infrared radiation, showing a bactericidal effect under a condition of low microbial concentration. Conversely, with a high microbial concentration, the resulting state becomes effective for activation of microorganisms. This phenomenon is the same as with microbubbles and nanobubbles.

Furthermore, imparting electric energy action to water molecules with magnetic force causes radicals, which are a strong activator substance, to be generated. These radicals, being unstable, tend to grab electrons so as to be stabilized. In such a case, oxidation action is exerted. This oxidation action fulfills treatment on organic matters contained in the water.

Thus, combining magnetic force and nanobubbles together causes increases in bactericidal property under less amounts of microorganisms as well as a strong activation of microorganisms under higher concentrations of microorganisms (this phenomenon is similar to those of microbubbles and nanobubbles), so that the cleaning of the filtering material in the rapid filter 19 or the activated carbon adsorption towers 29, 30 is strongly fulfilled. Particularly in the activated carbon adsorption towers 29, 30, microbial decomposition of adsorbed substances is strongly fulfilled by the adsorption of organic matters to the activated carbon as well as by the propagation and activation of microorganisms that have propagated on the activated carbon, with the result that activated carbon, as if it were automatically regenerated, becomes biological activated carbon for various types of liquids. The state of the biological activated carbon as if it were automatically regenerated is derived from the treatment that organic matters adsorbed by activated carbon are decomposed by microorganisms that have propagated on the activated carbon.

In this first embodiment, as an example, treatment water that passes through the first activated carbon adsorption tower 29, the electric valve 31, the electric valve 28, the second activated carbon adsorption tower 30 and the electric valve 32 is introduced via the pipe 34, the electric valve 36 and the pipe 39 to the treatment water tank 62. In this treatment water tank 62, since quite a large amount of unstable free radicals are generated due to the above-described magnetic-force nanobubbles, persistent organic matters such as organic fluorine compounds, when contained in the treatment water, can be decomposed.

The nanobubble generators in the first, second magnetic-force nanobubble generators 51, 52 may be commercially available ones without limitations on their manufacturers. As a concrete example of the nanobubble generators, a product (trade name: BUVITAS, Model HYK) by Kyowa Kisetsu Co., Ltd. may be adopted. Also, the magnetic activators 12, 48 are given in this case by a product (trade name: BCO HAPPINESS Model BK) by Business Center Organization Co., Ltd.) as an example.

Of the BCO HAPPINESS Model BK (trade name) as the magnetic activators 12, 48, its distance between N and S poles is set to 30 mm or less. Also, its N- and S-pole magnets are so formed as to result in their total weight of 60 kg. The magnetic activator, BCO HAPPINESS Model BK (trade name), is so arranged that magnets are so placed that lines of magnetic force are applied vertically to the flow of water within to the piping. Also, in this BK type magnetic activator, when the water flows across the lines of magnetic force, weak currents are generated by Fleming's rules. Action of the weak currents causes the bonds among water molecules to collapse, so that the clusters (molecular groups) are subdivided. Also, in the BK type magnetic activator, water is subdivided so that the function of absorbing oxygen is enhanced and that large amounts of oxygen is absorbed from outside air, thus making it possible to enhance the dissolved oxygen quantity.

Now, three types of bubbles are explained.

(i) Ordinary bubbles (air bubbles) rise in the water and, in the end, pop and vanish at the surface.
(ii) Microbubbles are fine bubbles as small as 10 to several tens of microns (μm) in diameter on their occurrence, and partly change into micro-nano bubbles by contraction motion after the occurrence.
(iii) Nanobubbles are bubbles having diameters of several hundreds of nanometers (nm) or less (typically, less than 1 micron diameters of 100 to 200 nm), being further smaller than microbubbles, it being said that the nanobubbles can exist in the water perpetually.

Then, micro-nano bubbles can be explained as bubbles in which microbubbles and nanobubbles are mixed together.

### Second Embodiment

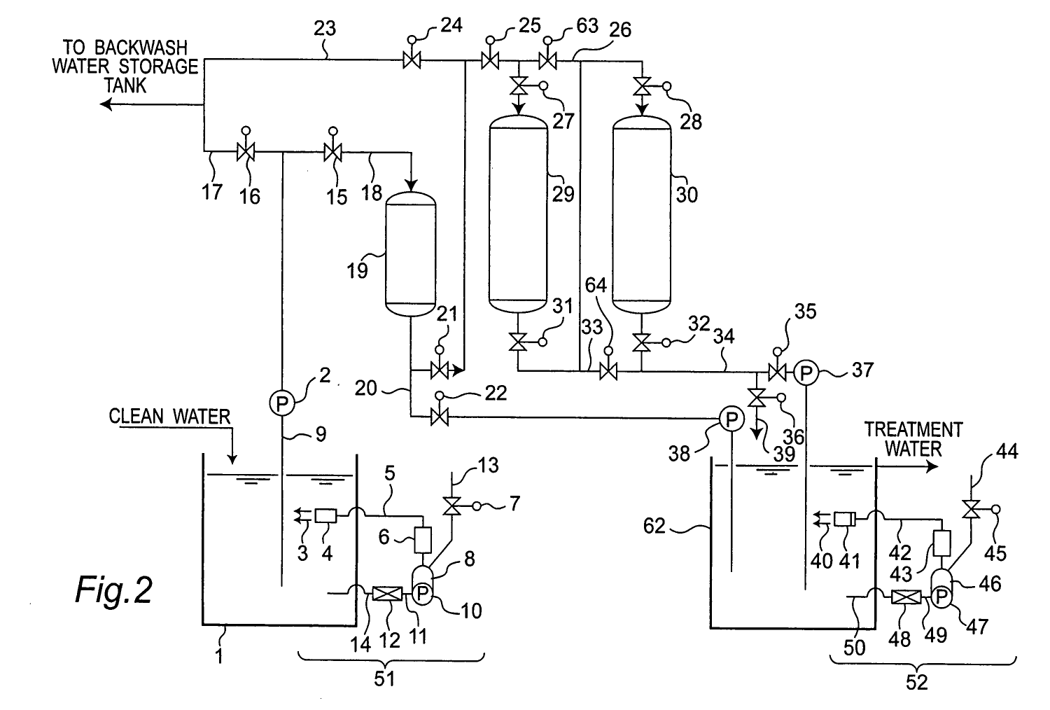

Next, FIG. 2 shows a second embodiment of the liquid treatment apparatus according to the invention. This second embodiment differs from the first embodiment in that the water introduced to the raw water tank 1 in the first embodiment is replaced with clean water. Therefore, in this second embodiment, the same component members as in the foregoing first embodiment are designated by like reference numerals, their detailed description being omitted, and differences from the first embodiment will be described below.

In the second embodiment, clean water as an example of water is introduced into the raw water tank 1. It is recently reported that persistent organic fluorine compounds were detected in tap water, which is clean water. Although the detected organic fluorine compounds are in trace amounts, yet organic fluorine compounds, even in trace amounts, are a considerably serious problem, forming an issue, from the viewpoints of their properties, accumulation in the human body, concentration and persistency.

Therefore, this second embodiment is directed toward treatment of organic fluorine compounds in clean water. That is, liquid treatment equipment of this second embodiment is equipment to be installed in water purification plants.

According to the second embodiment, organic fluorine compounds in the clean water are efficiently decomposed by magnetic-force nanobubbles, and those organic fluorine compounds that have not been decomposed are finally adsorbed to activated carbon. Then, activated carbon after the adsorption is extracted, carried into another place and subjected to incineration treatment at 1000° C. or higher, thus a treatment disposal method being established.

Further, while microorganisms that have propagated on activated carbon are activated by magnetic-force nanobubbles, there occurs a phenomenon that part of the organic fluorine compounds adsorbed to the activated carbon are decomposed. This is a case that organic fluorine compounds are those which are relatively easier to microbially decompose. In any case, by magnetic-force nanobubbles, (1) oxidative decomposition, (2) activated carbon adsorption, and (3) decomposition by microorganisms after the activated carbon adsorption, are effected, and finally (4) extraction and incineration of activated carbon after the adsorption are carried out.

### Third Embodiment

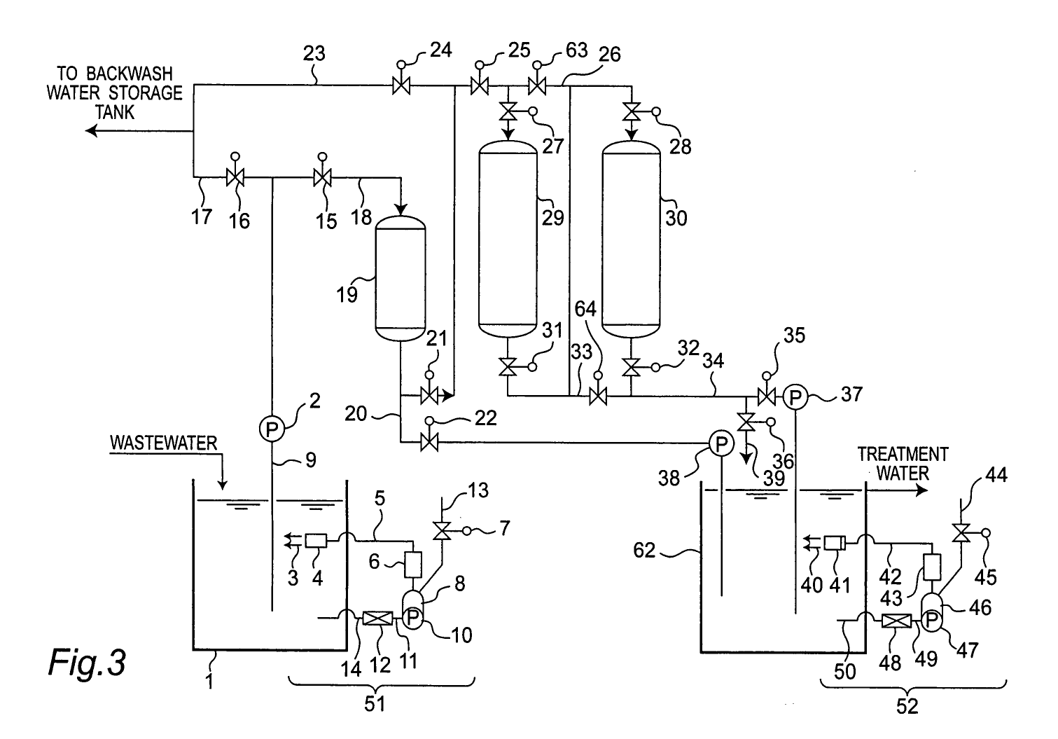

Next, FIG. 3 shows a third embodiment of the liquid treatment apparatus according to the invention. This third embodiment differs from the first embodiment in that the water introduced to the raw water tank 1 in the first embodiment is replaced with wastewater. Therefore, in this third embodiment, the same component members as in the foregoing first embodiment are designated by like reference numerals, their detailed description being omitted, and differences from the first embodiment will be described below.

In this third embodiment, wastewater as an example of water is introduced to the raw water tank 1 of the first embodiment.

Generally, various types of components are contained in wastewater. Particularly in the case where strict wastewater regulations are imposed or where wastewater is reused, such equipment as the rapid filter 19 and the activated carbon adsorption tower 29 is installed. In particular, with the absolute quantity of organic matters beyond the adsorption power, activated carbon abruptly deteriorates in performance. Then, activated carbon is extracted from the activated carbon tower, and regenerated at another place, and the regenerated activated carbon is filled again into the activated carbon tower. In this way, wastewater treatment equipment is kept running.

In contrast to this, the third embodiment is to treat organic matters contained in wastewater. That is, the treatment equipment in this third embodiment is to be installed at wastewater treatment sites in factories or the like. In the third embodiment, organic matters in the wastewater are efficiently decomposed by magnetic-force nanobubbles, and organic matters that remain undecomposed are finally adsorbed to activated carbon. Then, activated carbon after the adsorption is extracted, carried into another place and subjected to incineration treatment at 1000° C. or higher, thus a treatment disposal method being established.

Further, while microorganisms that have propagated on activated carbon are activated by magnetic-force nanobubbles, there occurs a phenomenon that part of the organic matters adsorbed to the activated carbon are decomposed. This is a case that organic matters are those which are relatively easier to microbially decompose. In any case, by magnetic-force nanobubbles, (1) oxidative decomposition, (2) activated carbon adsorption, and (3) decomposition by microorganisms after the activated carbon adsorption, are effected, and finally (4) extraction and incineration of activated carbon after the adsorption are carried out.

In the third embodiment, microorganisms that have propagated on activated carbon can be activated by magnetic-force nanobubbles. Also, organic matters in the wastewater adsorbed by the activated carbon are oxidatively decomposed by free radicals generated due to magnetic-force nanobubbles, so that the life of the activated carbon (activated carbon life as it is called in the industry) can be prolonged.

### Fourth Embodiment

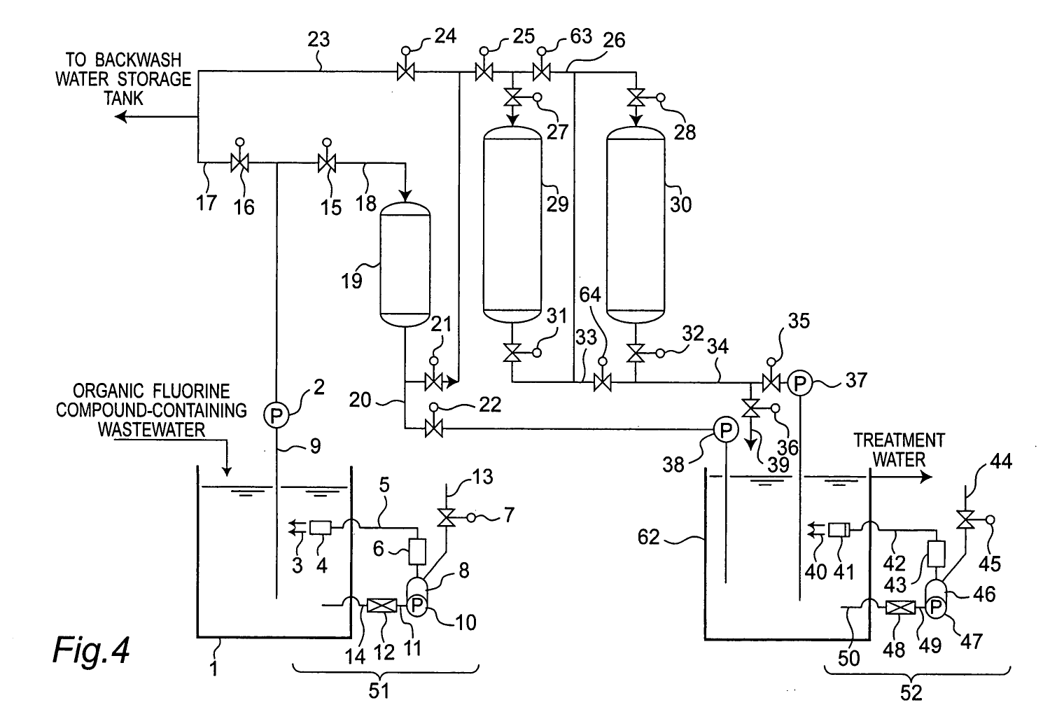

Next, FIG. 4 shows a fourth embodiment of the liquid treatment apparatus according to the invention. This fourth embodiment differs from the first embodiment in that the water introduced to the raw water tank 1 in the foregoing first embodiment is replaced with organic fluorine compound-containing wastewater. Therefore, in this fourth embodiment, the same component members as in the first embodiment are designated by like reference numerals, their detailed description being omitted, and differences from the first embodiment will be described below.

In this fourth embodiment, organic fluorine compound-containing wastewater instead of water is introduced into the raw water tank 1.

It has recently been reported that organic fluorine compounds in wastewater were discharged upstream in rivers and streams, taken in through water intakes of downstream water service as the organic fluorine compounds remained undecomposed by the purification action of the rivers and streams, coming out as clean supply water, where persistent organic fluorine compounds were detected in tap water.

Although the detected organic fluorine compounds are in trace amounts, yet organic fluorine compounds, even in trace amounts, are a considerably serious problem, forming an issue, from the viewpoints of their properties, accumulation In the human body, concentration and persistency.

Therefore, organic fluorine compound-containing wastewater as treatment water needs to be treated securely. That is, in this fourth embodiment, organic fluorine compounds in wastewater are efficiently oxidatively decomposed by magnetic-force nanobubbles, and organic matters that remain undecomposed are finally adsorbed to activated carbon. Then, activated carbon after the adsorption is subjected to incineration treatment at 1000° C. or higher, thus a treatment disposal method for organic fluorine compounds being established.

Also, as microorganisms activated by magnetic-force nanobubbles are propagated on activated carbon, there occurs a phenomenon that part of the organic fluorine compounds adsorbed to the activated carbon are decomposed by the microorganisms, which are excellent in microbial decomposition power. This is a case that organic fluorine compounds are those which are relatively easier to microbially decompose. In any case, by magnetic-force nanobubbles, (1) oxidative decomposition, (2) activated carbon adsorption, and (3) decomposition by microorganisms after the activated carbon adsorption, are effected, and finally (4) extraction and incineration of activated carbon after the adsorption are carried out. Further, magnetic-force nanobubbles get into fine parts of activated carbon, organic fluorine compounds adsorbed to the activated carbon are partly decomposed by unstable oxidation action of magnetic-force nanobubbles.

### Fifth Embodiment

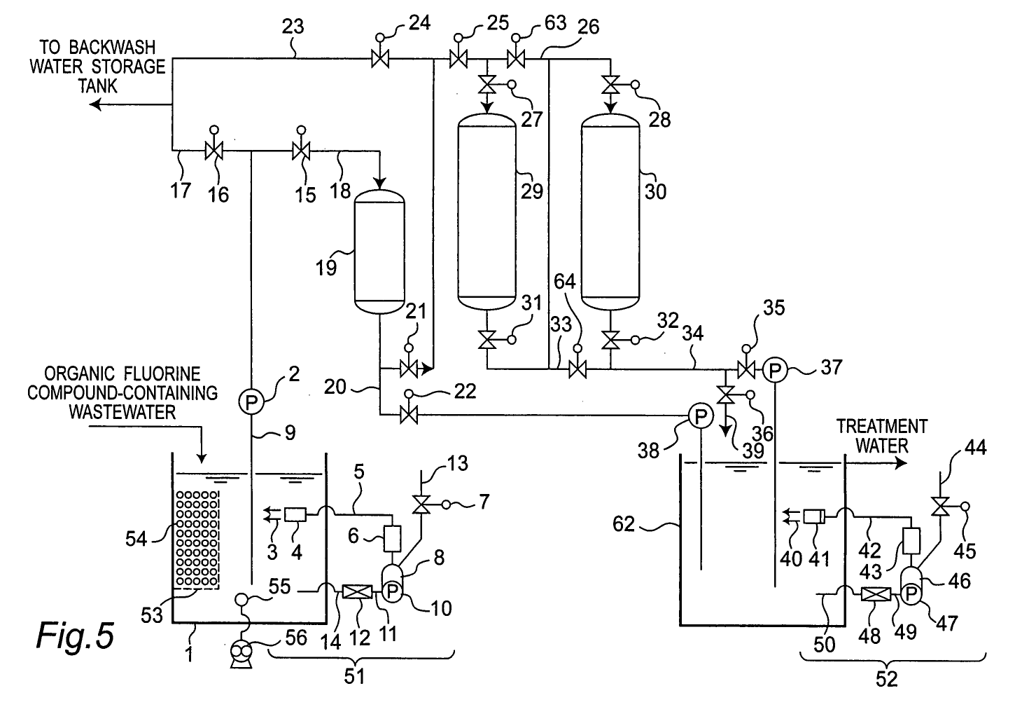

Next, FIG. 5 shows a fifth embodiment of the liquid treatment apparatus according to the invention. This fifth embodiment differs from the foregoing fourth embodiment in that charcoal is filled in the raw water tank 1 in the fourth embodiment. Therefore, in this fifth embodiment, the same component members as in the fourth embodiment are designated by like reference numerals, their detailed description being omitted, and differences from the fourth embodiment will be described below.

In this fifth embodiment, in the raw water tank 1, charcoal 54 such as bincho charcoal that has not as high adsorptive power as activated carbon but more or less adsorptive power is filled in an accommodating basket 53. As a result of this, the raw water tank 1 serves as a pretreatment water tank for the activated carbon adsorption tower 29 and the activated carbon adsorption tower 30, making it possible to prolong the life of the activated carbon filled in the activated carbon adsorption tower 29 and the activated carbon adsorption tower 30. That is, the charcoal 54 adsorbs organic matters in the organic fluorine compound-containing wastewater, or microorganisms activated by magnetic-force nanobubbles propagate on the charcoal 54, by which the organic matters are treated.

### Sixth Embodiment

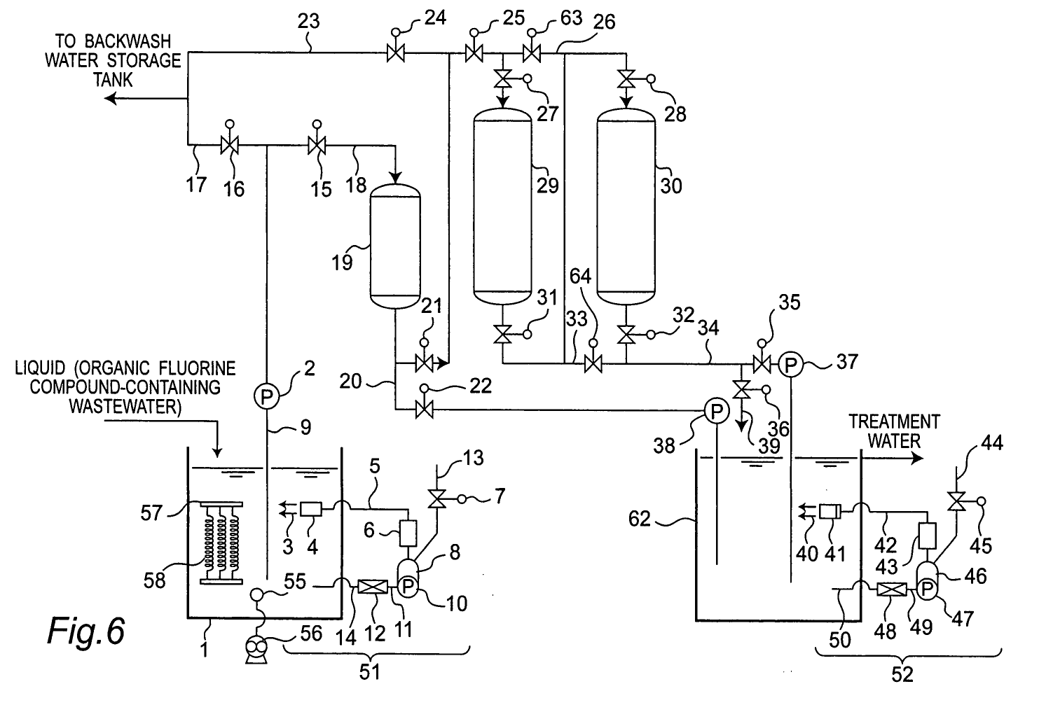

Next, FIG. 6 shows a sixth embodiment of the liquid treatment apparatus according to the invention. This sixth embodiment differs from the foregoing fourth embodiment in that, instead of charcoal, a string-shaped type polyvinylidene chloride filler 58 are filled in the raw water tank 1 in the fourth embodiment. Therefore, in this sixth embodiment, the same component members as in the fourth embodiment are designated by like reference numerals, their detailed description being omitted, and differences from the fourth embodiment will be described below.

In this sixth embodiment, in the raw water tank 1, a string-shaped type polyvinylidene chloride filler 58 fitted to fixing metal fittings 57 are filled. As a result of this, the raw water tank 1 serves as a pretreatment water tank for the activated carbon adsorption tower 29 and the activated carbon adsorption tower 30, making it possible to prolong the life of the activated carbon filled in the activated carbon adsorption tower 29 and the activated carbon adsorption tower 30. That is, microorganisms activated by magnetic-force nanobubbles propagate on the string-shaped type polyvinylidene chloride filler 58, so that the organic matters in the organic fluorine compound-containing wastewater is treated.

### Seventh Embodiment

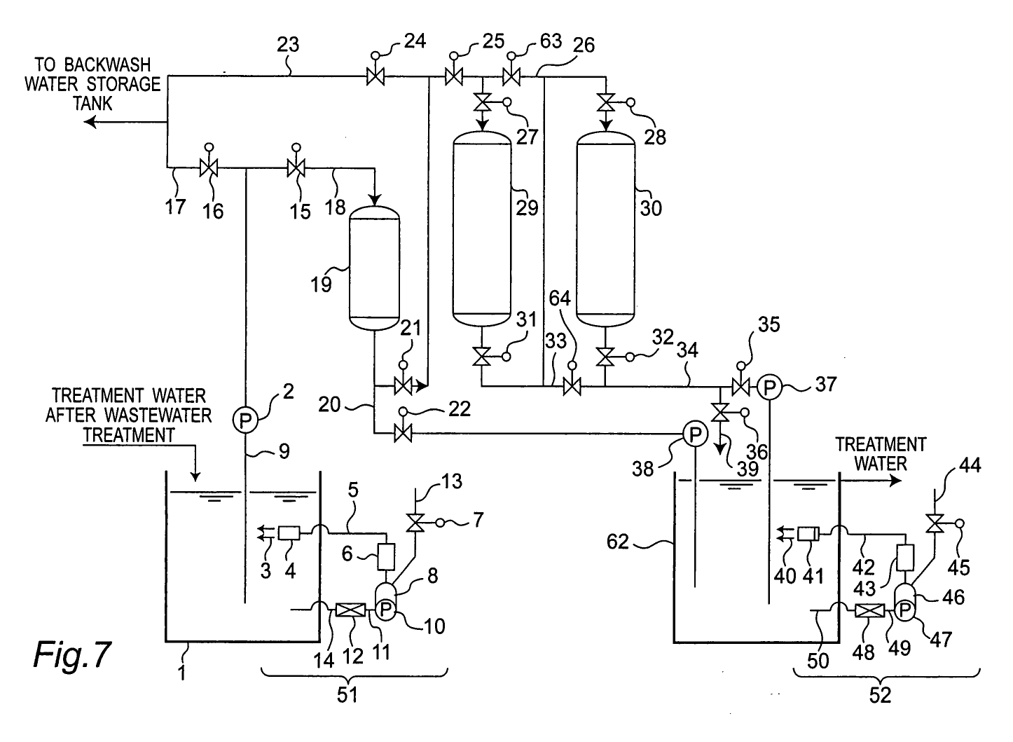

Next, FIG. 7 shows a seventh embodiment of the liquid treatment apparatus according to the invention. This seventh embodiment differs from the foregoing first embodiment in that the liquid introduced to the raw water tank 1 in the first embodiment is replaced with treatment water after wastewater treatment. Therefore, in this seventh embodiment, the same component members as in the foregoing first embodiment are designated by like reference numerals, their detailed description being omitted, and differences from the first embodiment will be described below.

In this seventh embodiment, wastewater treatment water instead of liquid is introduced into the raw water tank 1. Therefore, in the seventh embodiment, treatment water after wastewater treatment is introduced into the raw water tank 1 so as to be treated at high grade by the rapid filter 19, the activated carbon adsorption tower 29 and the activated carbon adsorption tower 30.

By this seventh embodiment, since treatment water after wastewater treatment can be treated at high grade, treatment water of such water quality as can be reused can be obtained from the treatment water tank 62. Also, the treated water comes to have such effluent water quality as can be favorably applied to regions of quite strict effluent regulations. Applications of the reuse include process water in various types of factories, general service water for various types of buildings, cooling water for cooling towers in various types of factories, scrubber water, water for chemicals used in a wastewater treatment equipment, and the like.

### Eighth Embodiment

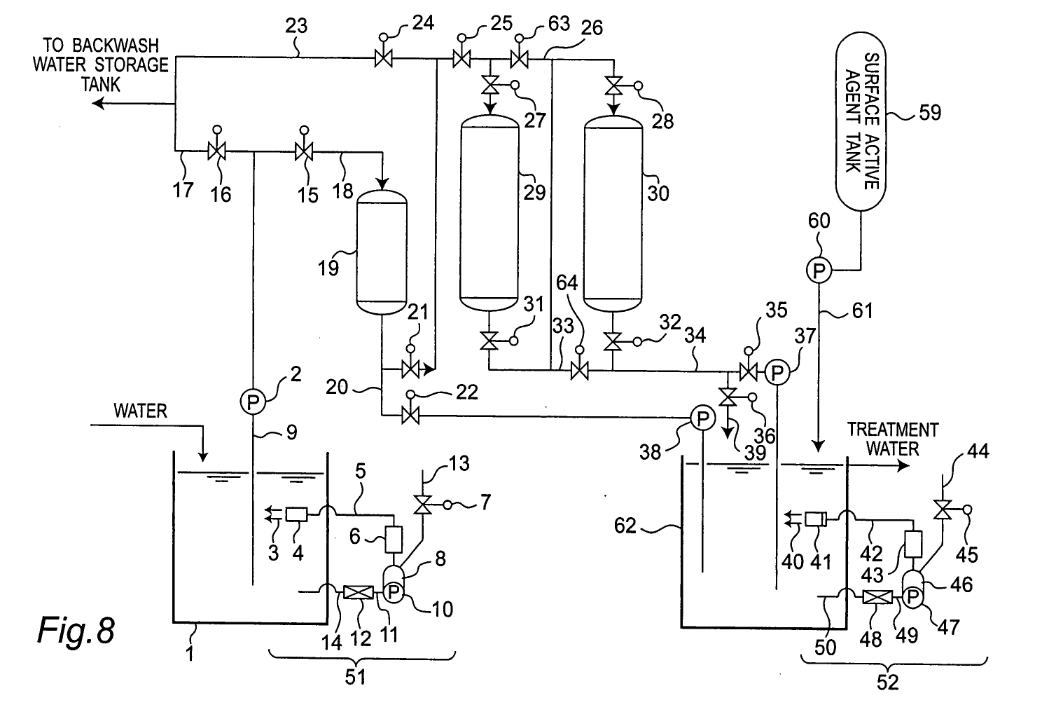

Next, FIG. 8 shows an eighth embodiment of the liquid treatment apparatus according to the invention. This eighth embodiment differs from the first embodiment in that a surface active agent tank 59 and a metering pump 60 are newly provided and a surface active agent is added to the treatment water tank 62. Therefore, in this eighth embodiment, the same component members as in the foregoing first embodiment are designated by like reference numerals, their detailed description being omitted, and differences from the first embodiment will be described below.

In this eighth embodiment, for backwashing of the activated carbon adsorption tower 30, the electric valve 64 provided on the pipe 33 is closed while the electric valves 35, 32 are opened to allow the backwashing of the activated carbon adsorption tower 30 to be carried out. Also, industrial water as backwash water is resupplied to the treatment water tank 62. Then, by operating the metering pump 60, the surface active agent is added from the surface active agent tank 59 via a chemical feed pipe 61 to the treatment water tank 62, so that the generation efficiency of nanobubbles is greatly enhanced. This is a measure against reduction of the nanobubble generation efficiency which might occur with higher water quality. The addition amount of the surface active agent is set to a criterial trace amount of 2 ppm or less.

When any surface active agent is contained in the backwash water, the detergent efficiency for activated carbon is increased, so that organic matters having adhered to activated carbon after long-term use of the activated carbon can be washed with high efficiency.

For backwashing of the activated carbon adsorption tower 29, the electric valves 64, 35 are opened while the electric valve 32 is closed so as to allow the backwashing of the activated carbon adsorption tower 29 to be carried out. Also, with the electric valves 64, 36 opened, treatment water derived from the activated carbon adsorption tower 29 can be introduced to the treatment water tank 62.

### Ninth Embodiment

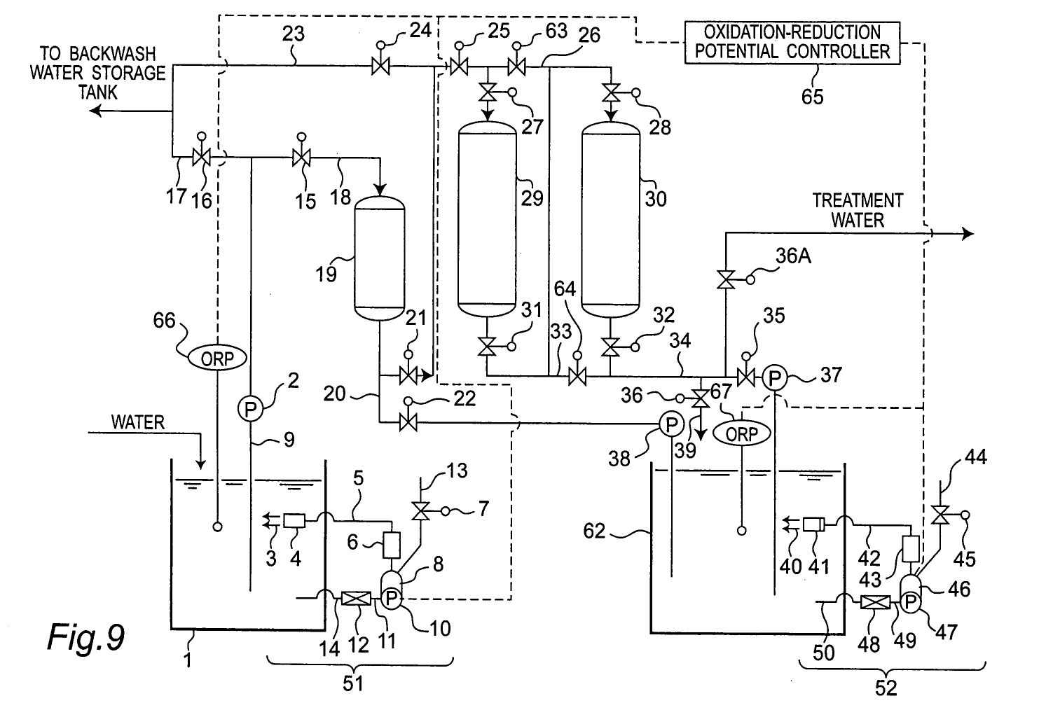

Next, FIG. 9 shows a ninth embodiment of the liquid treatment apparatus according to the invention. This ninth embodiment differs from the first embodiment in that an oxidation-reduction potentiometer (ORP) is provided for the raw water tank 1 and the treatment water tank 62 in the first embodiment, and that an oxidation-reduction potential controller 65 is additionally provided. Therefore, in this ninth embodiment, the same component members as in the foregoing first embodiment are designated by like reference numerals, their detailed description being omitted, and differences from the first embodiment will be described below.

In this ninth embodiment, a signal representing an oxidation-reduction potential of water within the raw water tank 1 measured by the ORP (oxidation-reduction potentiometer) 66 provided for the raw water tank 1 is inputted to the oxidation-reduction potential controller 65. This oxidation-reduction potential controller 65, based on the signal inputted thereto from the ORP 66, controls the operation of the gas-liquid mixing and circulating pump 10. Also, in this ninth embodiment, a signal representing an oxidation-reduction potential of treatment water within the treatment water tank 62 measured by an ORP (oxidation-reduction potentiometer) 67 provided for the treatment water tank 62 is inputted to the oxidation-reduction potential controller 65. This oxidation-reduction potential controller 65, based on the signal inputted thereto from the ORP 67, controls the operation of the gas-liquid mixing and circulating pump 47.

In the ninth embodiment, for the control of nanobubble generation quantity, signals derived from the ORP (oxidation-reduction potentiometer) 66 provided for the raw water tank 1 and the ORP (oxidation-reduction potentiometer) 67 provided for the treatment water tank 62 are received by the oxidation-reduction potential controller 65 to control the operation of the gas-liquid mixing and circulating pump 10 and the gas-liquid mixing and circulating pump 47. In the raw water tank 1 and the treatment water tank 62, there is a correlation between oxidation-reduction potential and nanobubble generation quantity. Therefore, the nanobubble generation quantity can be controlled by the operation control of the pumps 10, 47 based on the oxidation-reduction potential.

It is noted that nanobubbles, having negative electric charge, show negative potentials. Then, on/off operation is commonly applied, but rotating-speed control is of course also applicable for the operation. Further, given that a plurality of the first, second magnetic-force nanobubble generators 51, 52 are provided, the number of operated generators may also be controlled.

As a result of this, it becomes possible to implement operation control for the first magnetic-force nanobubble generator 51 and the second magnetic-force nanobubble generator 52 according to the treatment water quality. Also, electric power is required to some extent for the operation of the first magnetic-force nanobubble generator 51 and the second magnetic-force nanobubble generator 52. Therefore, in order to achieve energy saving, it is desirable to perform intermittent operation of the first, second magnetic-force nanobubble generators 51, 52, i.e. operate those generators only when necessary, by means of the ORP (oxidation-reduction potentiometer) 66, the ORP (oxidation-reduction potentiometer) 67, the oxidation-reduction potential controller 65 and the like. Also, when only the first magnetic-force nanobubble generator 51 is operated out of the first, second magnetic-force nanobubble generators 51, 52, it may well be done that with the electric valve 36 closed and an electric valve 36A opened, treatment water derived from the activated carbon adsorption towers 29, 30 is discharged out through the electric valve 36A without being passed through the treatment water tank 62.

### EXPERIMENTAL EXAMPLE

An experimental apparatus for the liquid treatment apparatus was manufactured based on the first embodiment shown in FIG. 1. The capacity of the raw water tank 1 in this experimental apparatus was set to about 4 m³, the capacity of the rapid filter 19 set to 1 m³, the capacity of the first activated carbon adsorption tower 29 set to 4 m³, the capacity of the second activated carbon adsorption tower 30 set to 4 m³, and the capacity of the treatment water tank 62 set to 8 m³. Also, with the power of the gas-liquid mixing and circulating pumps of the first and the second magnetic-force nanobubble generators 51 and 52 set respectively to 3.7 kw, the experimental apparatus was manufactured.

Then, with organic matter-containing wastewater introduced to the raw water tank 1, a one-month test run was carried out. As a result of measuring TOC (Total Organic Carbon) of the influent water introduced to the raw water tank 1 as well as TOC of the treatment water tank 62, the influent water to the raw water tank 1 showed 86 ppm, while the treatment water of the treatment water tank 62 showed 8 ppm.

The activated carbon life, whereas being three months as its common life, was 11 months in this experimental apparatus. Also, backwashing work for the rapid filter 19, the first activated carbon adsorption tower 29 and the second activated carbon adsorption tower 30 was able to be smoothly carried out. That is, while the backwash time is commonly 15 minutes, this experimental apparatus was able to complete the backwashing in 5 minutes. With this 5 minute backwashing, pressure losses in the rapid filter 19, the first activated carbon adsorption tower 29 and the second activated carbon adsorption tower 30 were able to be recovered.

Further, with PFOS (perfluorooctane sulfonate) as an organic matter added to the influent water, after-operation PFOS (perfluorooctane sulfonate) in the treatment water tank 62 was measured to determine its removal rate, which was 94%. It is noted that the measurement of PFOS was conducted by TORAY RESEARCH CENTER, Inc., and measurement equipment used for the measurement was a liquid chromatographic tandem-type mass spectrometer.

Embodiments of the invention being thus described, it will be obvious that the same may be varied in many ways.

Such variations are not to be regarded as a departure from the spirit and scope of the invention, and all such modifications as would be obvious to one skilled in the art are intended to be included within the scope of the following claims.

1. A liquid treatment apparatus comprising:
a magnetic field generation section for subjecting a liquid to action of a magnetic field; and
a nanobubble generator for generating nanobubbles in the liquid subjected to the action of the magnetic field.

2. The liquid treatment apparatus as claimed in claim 1, wherein
the magnetic field generation section is
a magnetic force activator which releases lines of magnetic force to between N and S poles of a magnet to pass the liquid through between the N and S poles so that the liquid is subjected to action of magnetism.

3. The liquid treatment apparatus as claimed in claim 1, wherein
the nanobubble generator has a microbubble generation section, and a gas shearing section for shearing microbubbles generated in the microbubble generation section to generate nanobubbles.

4. The liquid treatment apparatus as claimed in claim 3, wherein
the gas shearing section includes a first gas shearer and a second gas shearer of a stage succeeding the first gas shearer.

5. The liquid treatment apparatus as claimed in claim 1, further comprising:
a raw liquid tank in which a first magnetic-force nanobubble generator having the magnetic force generation section and the nanobubble generator is set up; and
a rapid filter to which a nanobubble-containing liquid is introduced from the raw liquid tank;
an activated carbon adsorption tower to which a treatment liquid derived from the rapid filter is introduced; and
a treatment tank to which a treatment liquid derived from at least one of the rapid filter and the activated carbon adsorption tower is introduced, and in which a second magnetic-force nanobubble generator having the magnetic field generation section and the nanobubble generator is provided.

6. The liquid treatment apparatus as claimed in claim 1, wherein
the liquid to be introduced is water.

7. The liquid treatment apparatus as claimed in claim 1, wherein
the liquid to be introduced is clean water.

8. The liquid treatment apparatus as claimed in claim 1, wherein
the liquid to be introduced is wastewater.

9. The liquid treatment apparatus as claimed in claim 1, wherein
the liquid to be introduced is organic fluorine compound-containing wastewater.

10. The liquid treatment apparatus as claimed in claim 1, wherein
the liquid to be introduced is any one of treatment water after wastewater treatment, industrial water, drinking water, and bathwater.

11. The liquid treatment apparatus as claimed in claim 3, further comprising
a gas-liquid mixing and circulating pump having the microbubble generation section, wherein
the magnetic force activator is fitted on a suction pipe of the gas-liquid mixing and circulating pump.

12. The liquid treatment apparatus as claimed in claim 5, wherein
charcoal is filled in the raw liquid tank.

13. The liquid treatment apparatus as claimed in claim 5, wherein
activated carbon is filled in the raw liquid tank.

14. The liquid treatment apparatus as claimed in claim 5, wherein
a string-shaped type polyvinylidene chloride filler is filled in the raw liquid tank.

15. The liquid treatment apparatus as claimed in claim 5, wherein
a surface active agent is added to the treatment tank.

16. The liquid treatment apparatus as claimed in claim 5, further comprising:
a first oxidation-reduction potentiometer for measuring an oxidation-reduction potential of the liquid in the raw liquid tank;
a second oxidation-reduction potentiometer for measuring an oxidation-reduction potential of the liquid in the treatment tank; and
an oxidation-reduction potential controller to which first, second signals representing oxidation-reduction potentials measured by the first, second oxidation-reduction potentiometers are inputted and from which control signals based on the inputted signals are outputted to the first, second magnetic-force nanobubble generators to perform on/off control of operation of the first, second magnetic-force nanobubble generators.

17. The liquid treatment apparatus as claimed in claim 5, wherein
a plurality of the first magnetic-force nanobubble generators are provided for the raw liquid tank, and
a plurality of the second magnetic-force nanobubble generators are provided for the treatment tank, the liquid treatment apparatus further comprising:
a first oxidation-reduction potentiometer for measuring an oxidation-reduction potential of the liquid in the raw liquid tank;
a second oxidation-reduction potentiometer for measuring an oxidation-reduction potential of the liquid in the treatment tank; and
an oxidation-reduction potential controller to which first, second signals representing oxidation-reduction potentials measured by the first, second oxidation-reduction potentiometers are inputted and from which control signals based on the inputted signals are outputted to the plurality of the first, second magnetic-force nanobubble generators to perform control of a number of operating ones out of the first, second magnetic-force nanobubble generators.

18. A liquid treatment method comprising the step of passing a liquid through a magnetic field so that nanobubbles are generated in the liquid passed through the magnetic field.

19. The liquid treatment method as claimed in claim 18, wherein
the liquid is passed through a magnetic-force nanobubble generator in which a magnetic field generation section and a nanobubble generator are connected in sequence so that a magnetic-force nanobubble-containing liquid is generated.

20. The liquid treatment method as claimed in claim 19, wherein
the nanobubble generator has a microbubble generation section, and a gas shearing section for shearing microbubbles generated in the microbubble generation section to generate nanobubbles.

21. The liquid treatment method as claimed in claim 18, wherein
the liquid which has been passed through the magnetic field and in which nanobubble have been generated is treated in an activated carbon adsorption tower.

22. The liquid treatment method as claimed in claim 21, further comprising the step of:
backwashing the activated carbon adsorption tower with a nanobubble-containing backwash liquid having nanobubbles contained in a backwash liquid or with a magnetic-force nanobubble-containing backwash liquid obtained by subjecting the nanobubble-containing backwash liquid to action of a magnetic field.

23. The liquid treatment method as claimed in claim 18, further comprising the step of:
filtering the liquid, which has been passed through the magnetic field and in which nanobubbles have been generated, by means of a filtering unit or a tank filter.

24. The liquid treatment method as claimed in claim 23, further comprising the step of:
backwashing the filtering unit or a tank filter with a nanobubble-containing backwash liquid having nanobubbles contained in a backwash liquid or with a/magnetic-force nanobubble-containing backwash liquid obtained by subjecting the nanobubble-containing backwash liquid to action of a magnetic field.
